(19) United States
(12) Patent Application Publication
(10) Pub. No.: US 2026/0235444 A1
(43) Pub. Date: Aug. 13, 2026

(54) SPECTRAL INFORMATION GENERATION DEVICE, SPECTRAL INFORMATION GENERATION SYSTEM, AND SPECTRAL INFORMATION GENERATION METHOD

(71) Applicant: Sony Semiconductor Solutions Corporation, Kanagawa (JP)

(72) Inventor: Seichi OTSUKI, Kanagawa (JP)

(73) Assignee: Sony Semiconductor Solutions Corporation, Kanagawa (JP)

(21) Appl. No.: 19/469,431

(22) PCT Filed: Apr. 18, 2024
(86) PCT No.: PCT/JP2024/015478

§ 371 Date: Sep. 26, 2025

Related U.S. Application Data
(60) Provisional application No. 63/462,395, filed on Apr. 27, 2023.

(51) Int. Cl. G01J 3/28; G01J 3/12

(52) U.S. Cl. CPC G01J 3/2823; G01J 3/12; G01J 3/2803; G01J 2003/1213; G01J 2003/2813; G01J 2003/2826

(57) ABSTRACT

Both improvement of resolution and appropriate distance information calculation are achieved. A spectral information generation device includes a distance information calculation unit configured to calculate distance information on the basis of first spectral information including an imaging signal for each of a plurality of wavelength bands of a first spectroscopic camera and second spectral information including an imaging signal for each of a plurality of wavelength bands, of a second spectroscopic camera, different from the plurality of wavelength bands of the first spectroscopic camera but partially including wavelength bands common to the plurality of wavelength bands of the first spectroscopic cameras, and a spectroscopic processing unit configured to generate output spectral information on the basis of the first spectral information and the second spectral information.

### CROSS REFERENCE TO RELATED APPLICATIONS

This application claims priority to, and the benefit of, U.S. provisional patent application Ser. No. 63/462,395 filed on Apr. 27, 2023, incorporated herein by reference in its entirety.

### TECHNICAL FIELD

The present technology relates to a spectral information generation device, a spectral information generation system, and a spectral information generation method.

### BACKGROUND ART

PTL 1 below discloses a technique related to an imaging device capable of acquiring image signals corresponding to a plurality of individual eye images forming a compound eye image for the same subject.

### CITATION LIST

### Patent Literature

PTL 1: JP 2017-208778A

### SUMMARY

### Technical Problem

The spectroscopic camera may require many pixel color filters for multi-wavelength image acquisition, and thus the spatial resolution tends to be low. In order to maintain the spatial resolution, the number of pixel color filters is minimized, but in this case, the spectral resolution is reduced because the spectral pattern is reduced.

Meanwhile, a configuration of a multi-camera is used for distance measurement using a camera. A similar configuration can be used in the case of the spectroscopic camera. In a sensing application using a camera, it is very useful that spectral and distance information can be simultaneously acquired. Note that the problem with the spatial resolution of the spectroscopic sensor described above is difficult to solve by the multi-camera configuration itself.

The present disclosure proposes a technique that achieves both improvement in spectral resolution and appropriate distance information calculation.

### Solution to Problem

A spectral information generation device according to the present technology includes a distance information calculation unit configured to calculate distance information on the basis of first spectral information that is an imaging signal for each of a plurality of wavelength bands of a first spectroscopic camera and second spectral information that is an imaging signal for each of a plurality of wavelength bands, of a second spectroscopic camera, different from the plurality of wavelength bands of the first spectroscopic camera but partially including wavelength bands common to the plurality of wavelength bands of the first spectroscopic camera, and a spectroscopic processing unit configured to generate output spectral information on the basis of the first spectral information and the second spectral information.

A spectral information generation device acquires spectral information from a plurality of spectroscopic cameras. As a result, the distance information can also be calculated. In this case, the first and second spectroscopic cameras output spectral information having different wavelength bands, but part of the wavelength bands overlap.

### BRIEF DESCRIPTION OF DRAWINGS

FIG. 1 is a block diagram of a spectroscopic camera of the present technology.

FIG. 2 is an explanatory diagram of an exemplary configuration of a pixel array unit included in a spectroscopic sensor.

FIG. 3 is an explanatory diagram of a narrowbanding process of the spectroscopic camera.

FIG. 4 is a block diagram of a spectral information generation device according to the embodiment.

FIG. 5 is an explanatory diagram of a pass wavelength band of a spectral filter group of a comparative example.

FIG. 6 is an explanatory diagram of the spectral filter group according to the embodiment.

FIG. 7 is an explanatory diagram of a pass wavelength band of the spectral filter group of the embodiment.

FIG. 8 is an explanatory diagram of a pass wavelength band of the spectral filter group of the embodiment.

FIG. 9 is an explanatory diagram of processing of a distance information calculation unit according to the embodiment.

FIG. 10 is an explanatory diagram of luminance image generation processing according to the embodiment.

FIG. 11 is an explanatory diagram of parallax information according to the embodiment.

FIG. 12 is an explanatory diagram of processing of a spectroscopic processing unit of the embodiment.

FIG. 13 is an explanatory diagram of spectral information synthesis of the spectroscopic processing unit of the embodiment.

FIG. 14 is a block diagram of an information processing device serving as the spectral information generation device of the embodiment.

FIG. 15 is a block diagram of a computer-based system on which embodiments of the present system may be implemented.

### DESCRIPTION OF EMBODIMENTS

Hereinafter, embodiments will be described in the following order.
<1. Spectroscopic camera>
<2. Configuration and processing of spectral information generation system>
<3. Configuration of information processing device>
<4. Notes>
<5. Summary and modifications>

### 1. Spectroscopic Camera

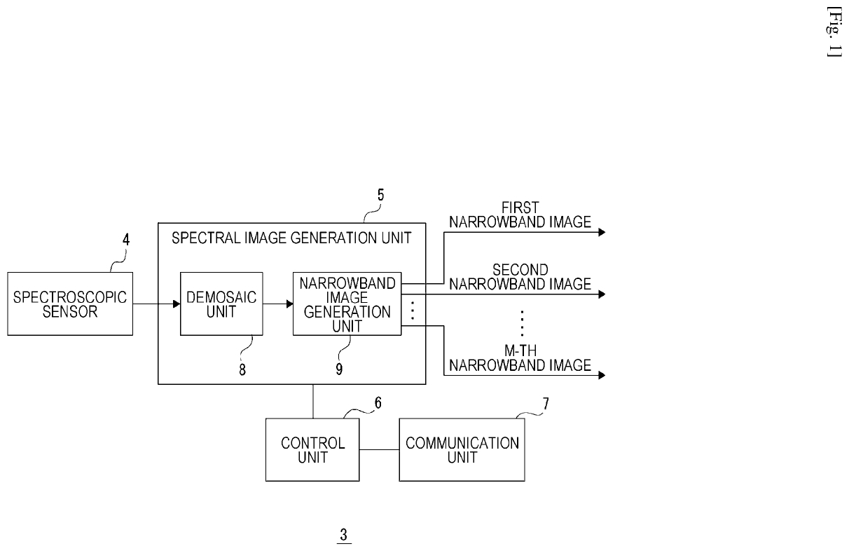

An example of a spectroscopic camera related to the present technology will be described with reference to FIGS. 1 to 3.

FIG. 1 is a block diagram illustrating a schematic configuration example of a spectroscopic camera 3.

Here, the “spectroscopic camera” means a camera including a spectroscopic sensor as a light receiving sensor. The “spectroscopic sensor” is a light receiving sensor for obtaining a plurality of narrowband images to be a wavelength characteristic analysis image for light from a subject.

As illustrated, the spectroscopic camera 3 includes a spectroscopic sensor 4, a spectral image generation unit 5, a control unit 6, and a communication unit 7.

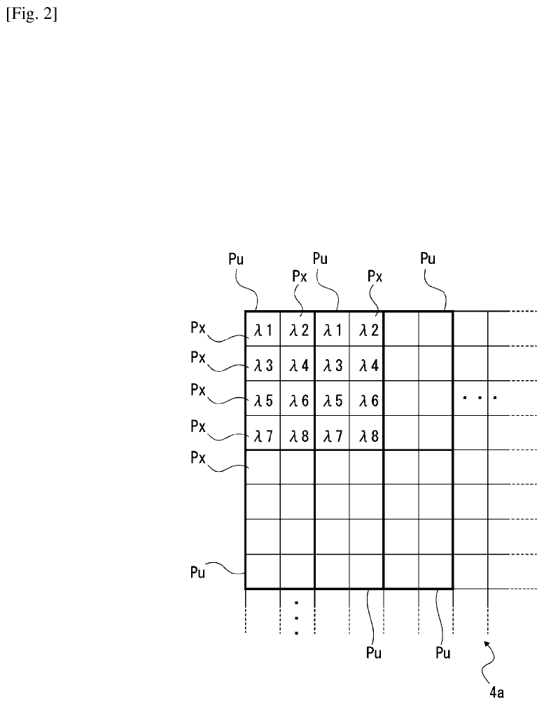

FIG. 2 is a diagram schematically illustrating a configuration example of a pixel array unit 4a included in the spectroscopic sensor 4.

As illustrated, in the pixel array unit 4a, a spectral pixel unit Pu in which a plurality of pixels Px each receiving light of different wavelength bands is two-dimensionally disposed in a predetermined pattern is formed. The pixel array unit 4a includes a plurality of spectral pixel units Pu disposed two-dimensionally.

In the example of the drawing, an example in which each of the spectral pixel units Pu individually receives light of a total of eight wavelength bands of λ1 to λ8 in the respective pixels Px, in other words, an example in which the number of wavelength bands divided to be received in each of the spectral pixel units Pu (hereinafter referred to as “number of light receiving wavelength channels”) is “8” is illustrated, but this is merely an example for description, and the number of light receiving wavelength channels in the spectral pixel unit Pu may be at least plural, and can be set to any number.

Hereinafter, the number of light receiving wavelength channels in the spectral pixel unit Pu is referred to as “N”.

In FIG. 1, the spectral image generation unit 5 generates M narrowband images on the basis of a RAW image as an image output from the spectroscopic sensor 4. Here, it is assumed that “M>N”, and for example, M=41 with respect to N=8.

The spectral image generation unit 5 includes a demosaic unit 8 and a narrowband image generation unit 9. The demosaic unit 8 performs a demosaic process on the RAW image from the spectroscopic sensor 4, and the narrowband image generation unit 9 performs a narrowbanding process (linear matrix processing) based on each of the N channel wavelength band images obtained by the demosaic process, thereby generating M narrowband images from the N wavelength band images.

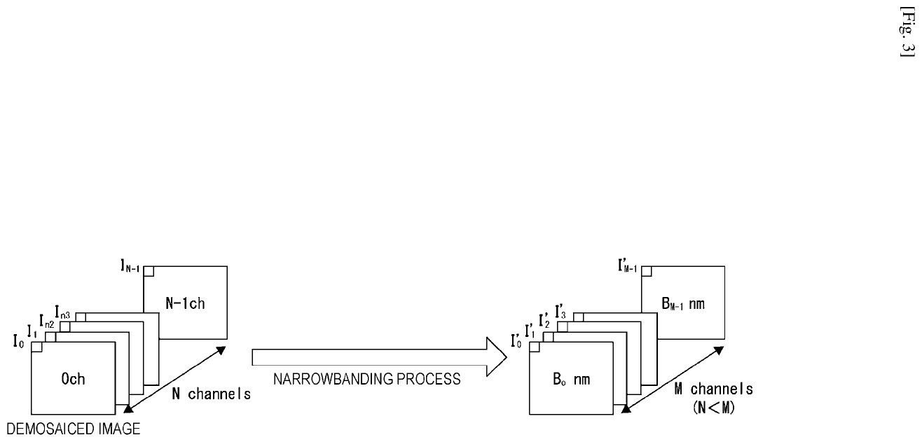

FIG. 3 is an explanatory diagram of the narrowbanding process for obtaining M narrowband images.

On the basis of the wavelength band images for N channels obtained by the demosaic process by the demosaic unit 8, for example, matrix operation as illustrated is performed for each pixel position to obtain narrowband images for M channels. In order to convert the wavelength band images for N channels into narrowband images for M channels in this manner, a process of obtaining pixel values (in the figure, IO to IN-1) for M channels by matrix operation using the pixel values (in the figure, I′0 to I′M-1) for N channels for each pixel position is a narrowbanding process.

Here, an arithmetic expression of the narrowbanding process can be expressed by the following [Equation 1] where R is a pixel value after demosaicing processing, n is an input wavelength channel (0 to N-1), C is a narrowbanding coefficient, B is an output pixel value by the narrowbanding process, and m is an output wavelength channel is (0 to M-1).

$$\begin{matrix}[ Math . 1 ] & \\ Bm = {\sum }_{n = 0}^{N - 1} ( R [ n ] * Cm [ n ] ) & [ Equation 1 ]\end{matrix}$$

That is, the pixel value B0 of the m=0th output wavelength channel=R[0]×C0[0]+R[1]×C0[1]+R[2]×C0[2]+ . . . +R[N-1]×C0[N-1], and the pixel value B1 of the m=first output wavelength channel=R[0]×C1[0]+R[1]×C1[1]+R[2]×C1[2]+ . . . +R[N-1]×C1[N-1].

Thereafter, similarly, the pixel value BM-1 of the last m=(M-1)-th output wavelength channel=R[0]×CM-1[0]+R[1]×CM-1[1]+R[2]×CM-1[2]+ . . . +R[N-1]×CM-1[N-1].

At this time, a total of N×M narrowbanding coefficients C of C0[0] to C0[N-1] for obtaining the pixel value B0, C1[0] to C1[N-1] for obtaining the pixel value B1, . . . , and CM-1[0] to CM-1[N-1] for obtaining the pixel value BM-1 are used.

In FIG. 1, the control unit 6 includes a microcomputer including, for example, a central processing unit (CPU), a read only memory (ROM), a random access memory (RAM), and the like, and performs overall control of the spectroscopic camera 3 by the CPU executing processing based on, for example, a program stored in the ROM or a program loaded in the RAM.

The communication unit 7 performs wired or wireless data communication with an external device. For example, the communication unit 7 may be configured to perform wired data communication with an external device according to a predetermined wired communication standard such as a Universal Serial Bus (USB) communication standard, wireless data communication with an external device according to a predetermined wireless communication standard such as a Bluetooth (registered trademark) communication standard, or wireless or wired data communication with an external device via a predetermined network such as the Internet.

The control unit 6 can transmit and receive data to and from an external device via the communication unit 7.

### 2. Configuration and Processing of Spectral Information Generation System

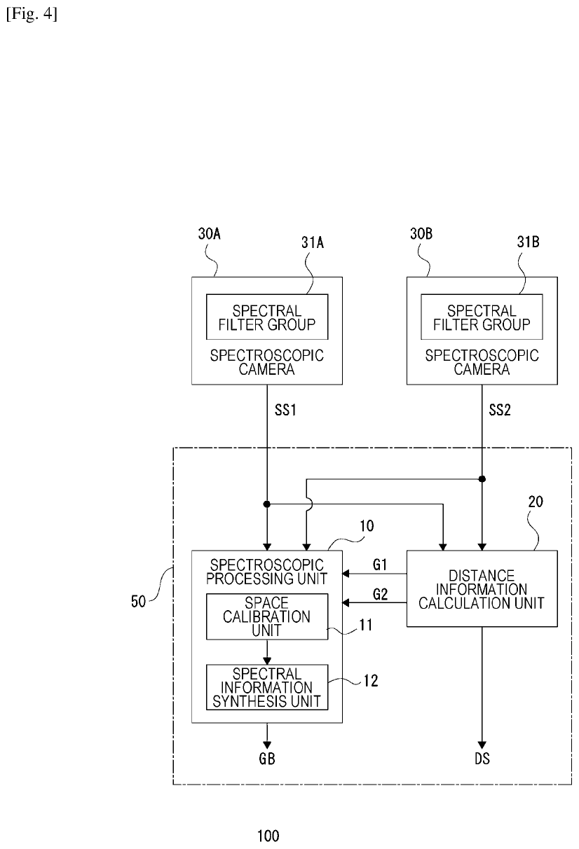

A spectral information generation system 100 of the present embodiment using the spectroscopic camera as described above will be described. FIG. 4 is a block diagram of spectral information generation system 100 according to the exemplary embodiment.

The spectral information generation system 100 includes two spectroscopic cameras 30A and 30B and a spectral information generation device 50. The spectroscopic camera 30A outputs spectral information SS1, and the spectroscopic camera 30B outputs spectral information SS2.

Each of the spectroscopic cameras 30A and 30B is a configuration of the spectroscopic camera 3 described with reference to FIGS. 1 to 3 to output a plurality of narrowband images. In FIG. 4, information including a plurality of narrowband images is illustrated as spectral information SS1 and SS2.

Alternatively, the spectroscopic camera (30A, 30B) here may be considered to correspond to the spectroscopic sensor 4 in FIG. 1. In this case, each of the spectral information SS1 and SS2 in FIG. 4 is information including RAW images of the number of light receiving wavelength channels of the spectroscopic sensor 4.

The spectroscopic camera 30A includes a spectral filter group 31A. The spectral filter group 31A refers to a set of pixel color filters corresponding to respective imaging pixels. A specific pass wavelength band is set for each pixel color filter. As a result, the pixel array unit 4a in which the plurality of spectral pixel units Pu described with reference to FIG. 2 is two-dimensionally disposed is formed.

The spectroscopic camera 30B includes a spectral filter group 31B. The spectral filter group 31B also indicates a set of pixel color filters corresponding to respective imaging pixels. A specific pass wavelength band is set for each pixel color filter, whereby the pixel array unit 4a in which the plurality of spectral pixel units Pu described in FIG. 2 is two-dimensionally disposed is formed.

In the present embodiment, the spectral filter groups 31A and 31B include pixel color filters of pass wavelength bands different from each other.

Although a specific example will be described later, it is assumed that the spectral filter group 31A includes pixel color filters of wavelength bands F1, F3, F5, F7, F9, F11, F13, and F15, which are narrow bands, when “F1” to “F16” represent specific wavelength bands. As a result, the pixel array unit 4a having the number of light receiving wavelength channels=8 is formed.

On the other hand, it is assumed that the spectral filter group 31B includes pixel color filters of wavelength bands F2, F4, F6, F8, F10, F12, F14, and F16 which are narrow bands. As a result, the pixel array unit 4a having the number of light receiving wavelength channels=8 is formed, but the pass wavelength band is a wavelength band different from that of the spectral filter group 31.

However, the wavelength bands are not completely divided in the spectral filter groups 31A and 31B, but at least part of the wavelength bands overlap, and information regarding common wavelength bands s included in the spectral information SS1 and SS2.

Each of the spectral information SS1 and SS2 is supplied to a spectroscopic processing unit 10.

The spectroscopic processing unit 10 includes a space calibration unit 11 and a spectral information synthesis unit 12.

The space calibration unit 11 performs a process of canceling the parallax between the spectral information SS1 and the spectral information SS2. The spectral information SS1 includes, for example, image data of 8 channels (Alternatively, narrowband image data of more multiple channels) imaged by the spectroscopic camera 30A. The spectral information SS2 includes, for example, image data of 8 channels (Alternatively, narrowband image data of more multiple channels) imaged by the spectroscopic camera 30B. Then, the image data of the spectral information SS1 and the image data of the spectral information SS2 include parallax due to the difference between the physical positions of the spectroscopic cameras 30A and 30B. The space calibration unit 11 calculates the parallax and aligns the images with each other (cancels the parallax).

The spectral information synthesis unit 12 synthesizes the spectral information SS1 and SS2 with the parallax canceled to generate and output the output spectral information GB.

Each of the spectral information SS1 and SS2 is also supplied to a distance information calculation unit 20.

The distance information calculation unit 20 calculates the distance to the subject using the parallax existing in the spectral information SS1 and SS2 to output the distance as a distance information DS.

Note that the spectral information generation device 50 can include, for example, one or a plurality of processors (information processing devices). The processes of the spectroscopic processing unit 10 and the distance information calculation unit 20 may be executed by the arithmetic function of the processor based on the software program.

Such a spectral information generation system 100 can achieve both improvement in spectral resolution and appropriate distance information calculation.

First, the main reason for including the two spectroscopic cameras 30A and 30B is to calculate distance information by obtaining parallax information. It is useful to simultaneously obtain spectral information and distance information.

Here, for the purpose of calculating distance information, it is normally assumed that the spectroscopic cameras 30A and 30B include the same spectral filter group.

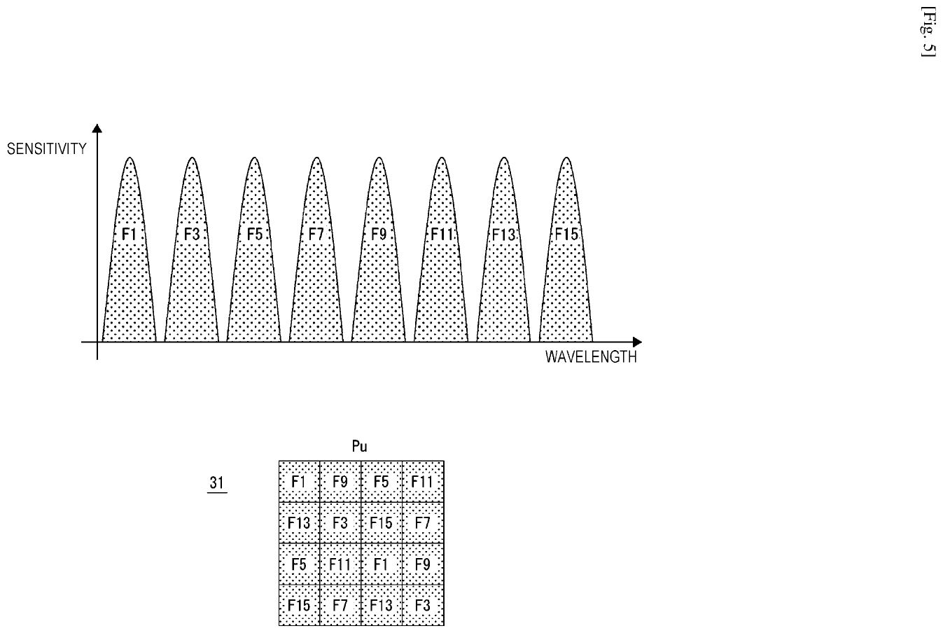

For example, FIG. 5 illustrates the spectral pixel unit Pu of the spectral filter group 31 including the pixel color filters of the wavelength bands F1, F3, F5, F7, F9, F11, F13, and F15. It is also conceivable that both the spectroscopic cameras 30A and 30B include such a spectral filter group 31. In this case, the spectral information SS1 and SS2 are images of the same wavelength bands of eight channels, for example. Rather, images in the same wavelength band (images under the same conditions) are desirable for parallax detection.

However, in this case, the number of spectral channels is small, which is disadvantageous in terms of spectral resolution. As described above, if the pixel color filters of more wavelength bands are provided, the spectral resolution can be improved, but as described above, this case is disadvantageous in terms of spatial resolution.

Therefore, in order to maintain the spatial resolution, it is considered to improve the spectral resolution while maintaining the condition of, for example, an 8-channel pixel color filters. Therefore, in the present embodiment, the spectral filter groups 31A and 31B of wavelength bands different from each other are used in the two spectroscopic cameras 30A and 30B.

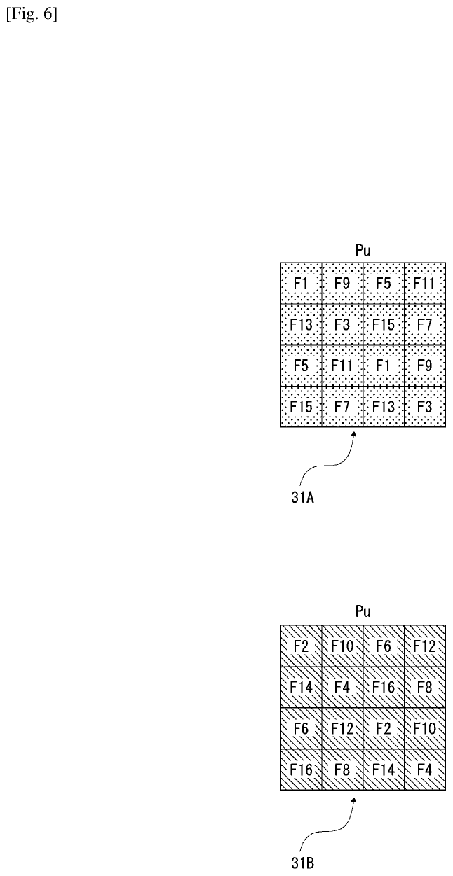

For example, as illustrated in FIG. 6, the spectral filter group 31A including the pixel color filters of the wavelength bands F1, F3, F5, F7, F9, F11, F13, and F15 is used for the spectroscopic camera 30A, and the spectral filter group 31B including the pixel color filters of the wavelength bands F2, F4, F6, F8, F10, F12, F14, and F16 is used for the spectroscopic camera 30B.

Then, the number of light receiving wavelength channels can also be increased, a larger number of narrowband images can be obtained by narrowing the band, and the spectral resolution can be increased while substantially maintaining the spatial resolution.

However, if the spectroscopic cameras 30A and 30B output images of completely different wavelength bands, it is disadvantageous for parallax detection for distance information calculation. Therefore, in the present embodiment, at least part of the wavelength bands overlaps and is imaged by the spectroscopic cameras 30A and 30B.

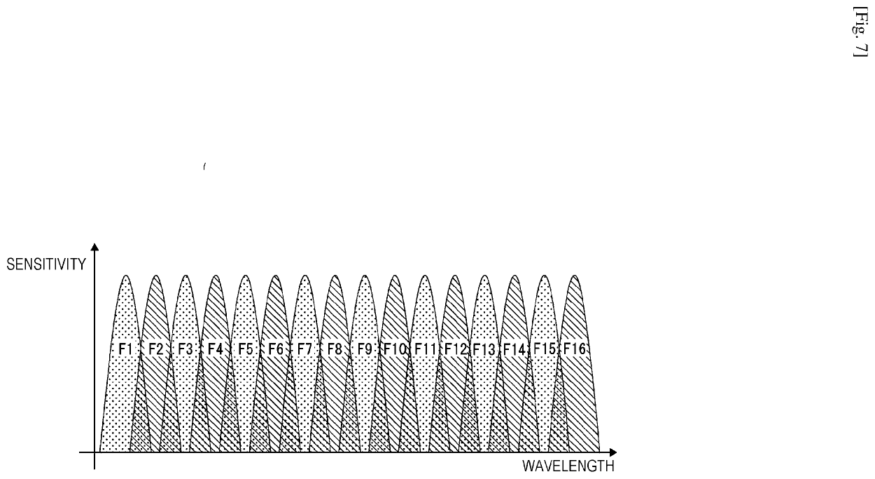

FIG. 7 illustrates light-receiving sensitivity-wavelength characteristics of the spectroscopic cameras 30A and 30B by the spectral filter groups 31A and 31B with the vertical axis as the sensitivity and the horizontal axis as the wavelength.

Wavelength bands F1, F2, F3, . . . , and F16 are provided from the low wavelength side to the high wavelength side. Among these, odd-numbered wavelength bands (F1, F3, . . . , F15) are pass wavelength bands by the pixel color filters included in the spectral filter group 31A. The even-numbered wavelength bands (F2, F4, . . . ,F16) are pass wavelength bands by the pixel color filters included in the spectral filter group 31B. That is, this is a state in which the pass wavelength bands of the pixel color filters included in the spectral filter group 31A and the pass wavelength bands of the pixel color filters included in the spectral filter group 31B are alternately disposed from the low wavelength side to the high wavelength side.

Furthermore, the adjacent pass wavelength bands overlaps each other in the vicinity of the boundary. For example, a boundary portion between the wavelength bands F1 and F2 is not clearly divided, and the wavelength bands overlap. The same applies to a boundary portion between the wavelength bands F2 and F3. Thereafter, the same applies to a boundary portions between the wavelength bands F15 and F16.

When the spectroscopic cameras 30A and 30B capture an image in such wavelength bands, the spectroscopic cameras 30A and 30B output spectral information SS1 and SS2 which are imaging signals for a plurality of wavelength bands having different wavelength bands but partially including common wavelength bands.

Then, the spectroscopic processing unit 10 can generate the output spectral information GB with high spectral resolution without sacrificing the spatial resolution.

In addition, the distance information calculation unit 20 can generate a luminance image having similar conditions due to the presence of the overlap section, calculate parallax, and generate the distance information DS.

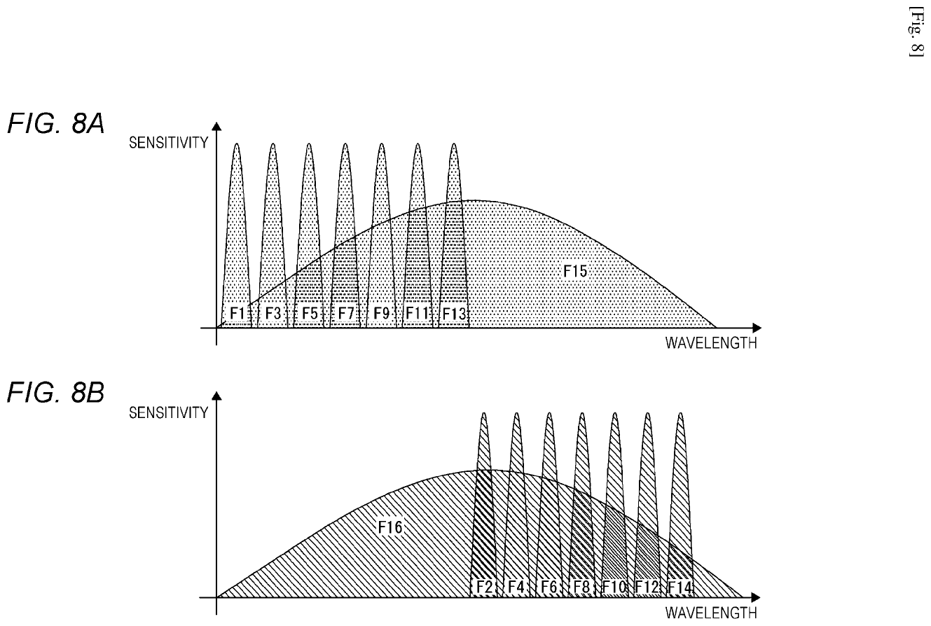

Note that the light-receiving sensitivity-wavelength characteristics of the spectroscopic cameras 30A and 30B are not limited to the example of FIG. 7. For example, examples such as FIGS. 8A and 8B are also conceivable.

FIG. 8A illustrates, for example, the light receiving sensitivity characteristic of the spectroscopic camera 30A by the spectral filter group 31A of FIG. 6, but the setting of the wavelength bands (F1, F3, . . . ,F15) is different from the example of FIG. 7. It is assumed that the wavelength bands F1, F3, F5, F7, F9, F11, and F13 are wavelength bands on a relatively low wavelength side. On the other hand, the wavelength band F15 is a wavelength band wide from the low wavelength side to the high wavelength side.

FIG. 8B illustrates the light receiving sensitivity characteristic of the spectroscopic camera 30B by the spectral filter group 31B of FIG. 6, but the setting of the wavelength bands (F2, F4, . . . ,F16) is different from the example of FIG. 7. It is assumed that the wavelength bands F2, F4, F6, F8, F10, F12, and F14 are wavelength bands on a relatively high wavelength side. On the other hand, the wavelength band F16 is a wavelength band wide from the low wavelength side to the high wavelength side.

In this case, there is no overlap between the wavelength bands F1, F3, . . . , and F13 and the wavelength bands F2, F4, . . . , and F14. However, the wavelength bands F15 and F16 are the same wavelength band and entirely overlap.

As described above, in the spectral filter group 31 and the spectral filter group 32, the wavelength bands (F15, F16) of some pixel color filters may be common, and the other pixel color filters may have different wavelength bands.

Specifically, since the wavelength bands F15 and F16 are assumed to be capable of obtaining high light receiving sensitivity in a wide wavelength range, the luminance images G1 and G2 under similar conditions can be easily generated from the spectral information SS1 and SS2, and are suitable for distance information calculation.

Note that, the present disclosure is not limited to the examples of FIGS. 7 and 8, but various examples of the light sensitivity-wavelength characteristic of each of the spectroscopic cameras 30A and 30B can be considered. In order to increase the spectral resolution, each has high sensitivity in different wavelength bands. In order to calculate the distance information, they are only required to partially include common wavelength bands.

Hereinafter, specific processing examples of the spectroscopic processing unit 10 and the distance information calculation unit 20 in FIG. 4 will be described.

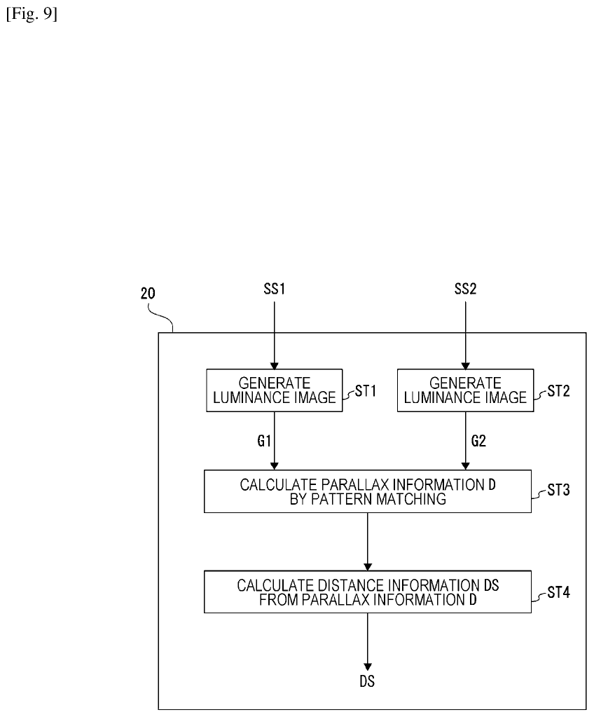

FIG. 9 illustrates a processing example of the distance information calculation unit 20.

At step ST1, the distance information calculation unit 20 performs a process of generating the luminance image G1 from the spectral information SS1. In addition, in step ST2, the distance information calculation unit 20 performs a process of generating the luminance image G2 from the spectral information SS2.

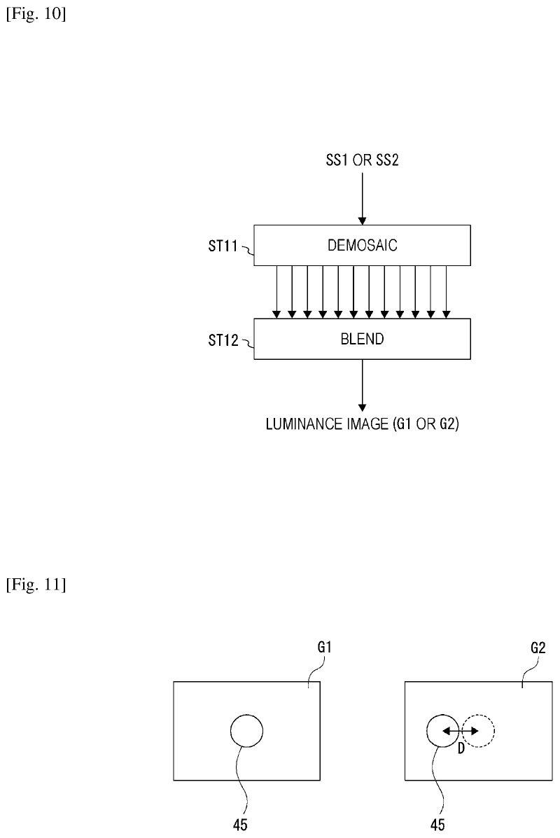

The luminance images G1 and G2 are images under equivalent conditions for parallax calculation. Therefore, as the luminance image generation process in steps ST1 and ST2, the distance information calculation unit 20 performs a process illustrated in FIG. 10.

The distance information calculation unit 20 performs a demosaic process in step ST11. This is a general demosaic process using bilinear interpolation or the like that aligns the spatial phase of each wavelength pixel.

The distance information calculation unit 20 performs a blending process in step ST12. For example, the signals of the respective wavelengths are averaged. In a case where there are many pieces of edge information at a specific wavelength, weighted addition, selection or the like with a large weight given to the edge information may be performed.

Through the above processing, the luminance image G1 is generated from the spectral information SS1, and the luminance image G2 is generated from the spectral information SS2.

In step ST3 of FIG. 9, the distance information calculation unit 20 performs a process of calculating parallax information D by pattern matching with respect to the ar-rangement direction of the spectroscopic cameras 30A and 30B.

FIG. 11 illustrates parallax corresponding to the parallax information D.

For example, the distance information calculation unit 20 extracts a subject 45 in the luminance image G2 of the spectroscopic camera 30B, performs pattern matching, and detects the same subject 45 in the luminance image G1. A difference in coordinates of the position of the subject 45 between the luminance images G1 and G2 is parallax information D.

In step ST4 of FIG. 9, the distance information calculation unit 20 calculates the distance information DS from the parallax information D on the basis of the principle of triangulation.

For example, when the inter-camera distance is B, the focal length is F, and the parallax is D,

$$Distance information DS = ( B \times F ) / D$$

The distance information calculation unit 20 outputs the distance information DS generated in this manner.

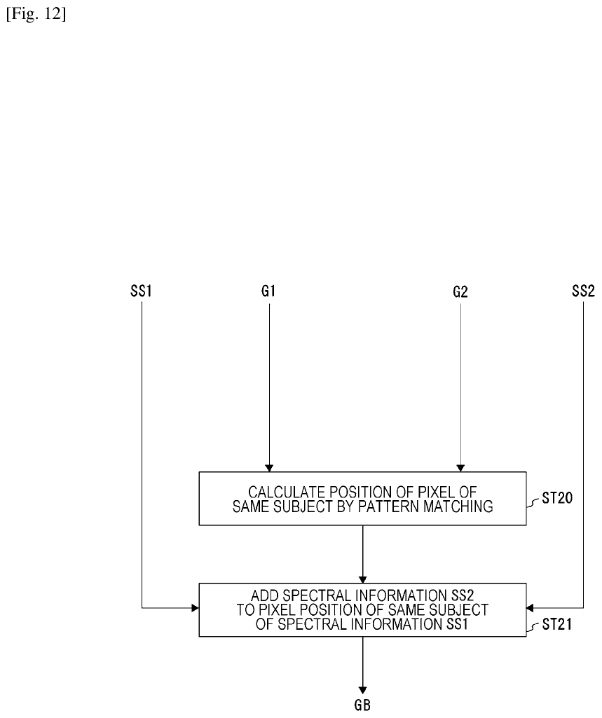

FIG. 12 illustrates a processing example of the spectroscopic processing unit 10. This is a processing example by the functions of the space calibration unit 11 and the spectral information synthesis unit 12 in the spectroscopic processing unit 10.

The luminance image G1 generated in step ST1 and the luminance image G2 generated in step ST2 of the distance information calculation unit 20 are provided to the spectroscopic processing unit 10.

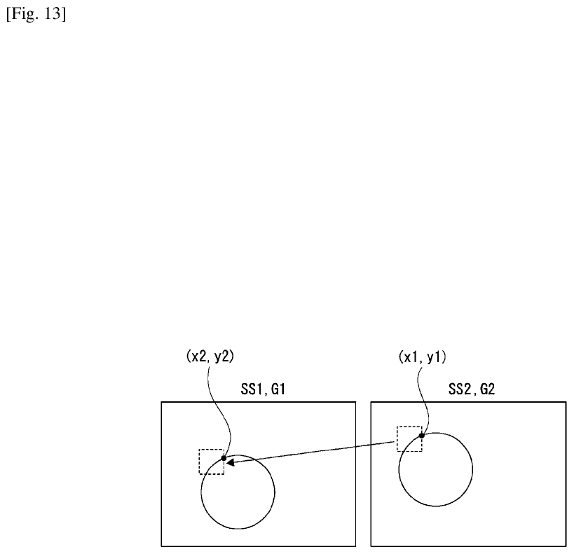

In step ST20, the spectroscopic processing unit 10 detects the same subject in the spectroscopic cameras 30A and 30B from the luminance images G1 and G2 by the pattern matching process. Then, the spectroscopic processing unit 10 calculates the position of the pixel of the same subject in the spectroscopic camera 30A for the subject in the spectroscopic camera 30B, for example. FIG. 13 illustrates coordinates (x2, y2) of the subject in the luminance image G1 corresponding to the coordinates (x1, y1) of the subject in the luminance image G2.

By detecting the corresponding coordinates of the feature points of some subjects in this manner, spatial calibration of the spectral information SS1 and SS2 can be performed.

In step ST21, processing of adding the spectral information SS2 to the pixel position of the same subject of the spectral information SS1, that is, processing of combining the spectral information SS1 and SS2 is performed on the basis of the result of step ST20. As a result, for example, it is possible to obtain the output spectral information GB including the spectral images of more channels in which the spectral images of the eight channels (alternatively, in a case where narrowband image generation processing is performed by the spectroscopic camera 30B, more channels are used) in the spectral information SS2 are synthesized with the spectral images of the eight channels (alternatively, in a case where narrowband image generation processing is performed by the spectroscopic camera 30A, more channels are used) in the spectral information SS1.

Furthermore, in step ST21, the spectroscopic processing unit 10 may perform a narrowband image generation process to obtain the output spectral information GB including spectral images of a larger number of channels.

With the above processing, the spectral information generation system 100 of the present embodiment can improve the spectral resolution as compared with the case where the spectroscopic cameras 30A and 30B have the same spectral sensitivity characteristic as described in FIG. 5.

### 3. Configuration of Information Processing Device

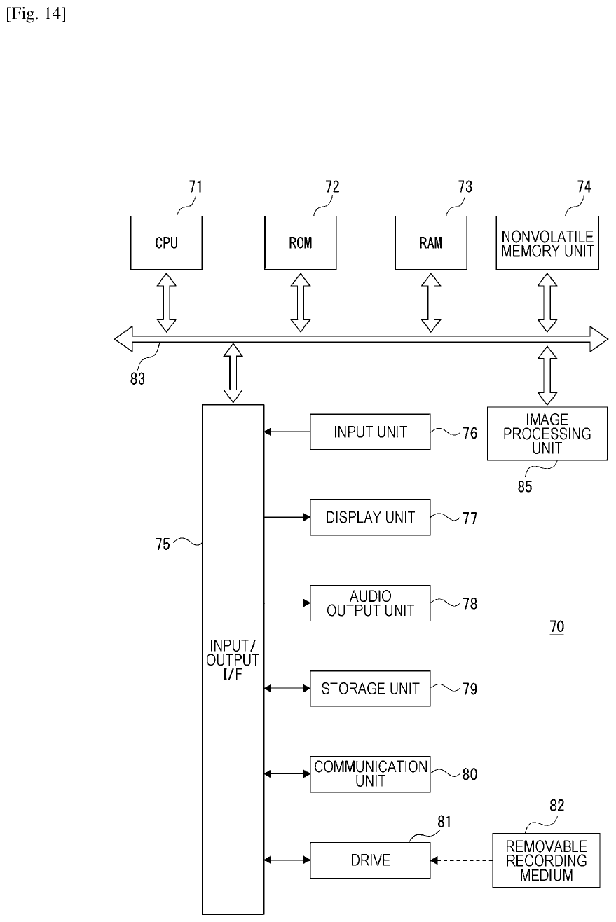

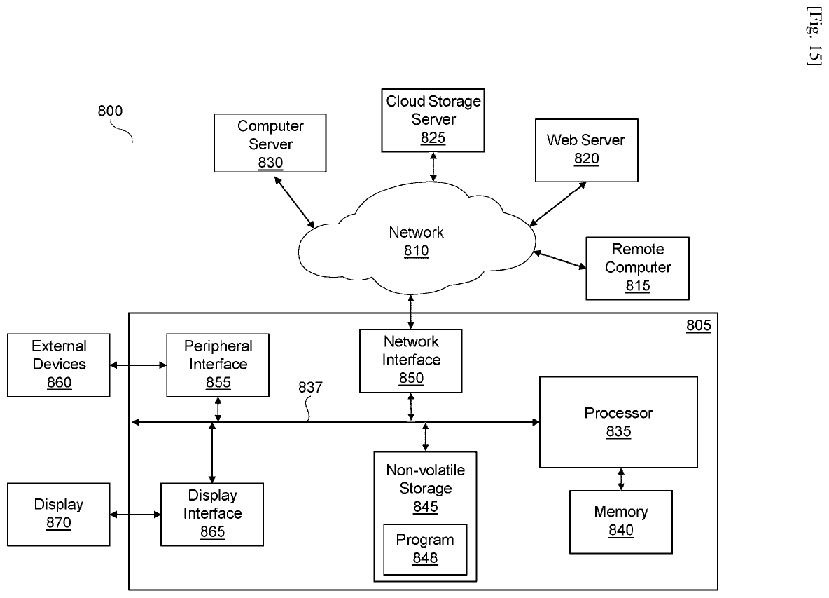

A configuration example of an information processing device 70 applicable as the spectral information generation device 50 will be described with reference to FIG. 14. The information processing device 70 is a device capable of performing information processing, such as a computer device. Specifically, a microprocessor and a peripheral device, a personal computer, a workstation, a portable terminal device such as a smartphone and a tablet, and the like are assumed as the information processing device 70. Furthermore, the information processing device 70 may be a computer device configured as a server device or an arithmetic device in cloud computing.

A central processing unit (CPU) 71 of the information processing device 70 illustrated in FIG. 14 executes various processes in accordance with a program stored in a nonvolatile memory unit 74 such as a read only memory (ROM) 72 or, for example, an electrically erasable programmable read only memory (EEP-ROM), or a program loaded from the storage unit 79 to a random access memory (RAM) 73. In addition, the RAM 73 also appropriately stores data and the like necessary for the CPU 71 to execute the various processes.

An image processing unit 85 performs various types of image processes. For example, any one of image synthesis, image analysis processing, image signal processing including color/luminance adjustment processing and color conversion processing, image editing processing, and the like, or a plurality of processing is performed.

The image processing unit 85 can be realized by, for example, a CPU, a graphics processing unit (GPU), general-purpose computing on graphics processing units (GPGPU), an artificial intelligence (AI) processor, or the like that is separate from the CPU 71.

Note that the image processing unit 85 may be provided as a function in the CPU 71.

The CPU 71, the ROM 72, the RAM 73, the nonvolatile memory unit 74, and the image processing unit 85 are connected to one another via a bus 83. An input/output interface 75 is also connected to the bus 83.

An input unit 76 configured with an operation element and an operation device is connected to the input/output interface 75. For example, as the input unit 76, various operators and operation devices such as a keyboard, a mouse, a key, a trackball, a dial, a touch panel, a touch pad, and a remote controller are assumed.

A user operation is detected by the input unit 76, and a signal corresponding to an input operation is interpreted by the CPU 71.

A microphone is also assumed as the input unit 76. A voice uttered by the user can also be input as the operation information.

Furthermore, a display unit 77 including a liquid crystal display (LCD), an organic electro-luminescence (EL) panel, or the like, and an audio output unit 78 including a speaker or the like are integrally or separately connected to the input/output interface 75.

A display unit 77 is a display unit that perform various types of displays, and includes, for example, a display device provided in a housing of the information processing device 70, a separate display device connected to the information processing device 70, or the like.

The display unit 77 displays various images, operation menus, icons, messages, and the like on the display screen, that is, as a GUI, on the basis of an instruction from the CPU 71.

In some cases, a storage unit 79 or a communication unit 80 including a hard disk drive (HDD), a solid state drive (SSD), or the like is connected to the input/output interface 75.

The storage unit 79 can store various pieces of data and programs. A database can be configured in the storage unit 79.

The communication unit 80 performs communication processing via a transmission path such as the Internet, wired/wireless communication with various devices such as an external database, an editing device, and an information processing device, bus communication, and the like.

In addition, a drive 81 is also connected to the input/output interface 75 as necessary, and a removable recording medium 82 such as a magnetic disk, an optical disk, a magneto-optical disk, a semiconductor memory, or the like is appropriately mounted.

The drive 81 can read video data, various computer programs, and the like from the removable recording medium 82. The read data is stored in the storage unit 79, and video and audio included in the data are output by the display unit 77 and the audio output unit 78. In addition, the computer program and the like read from the removable recording medium 82 are installed in the storage unit 79, as necessary.

In the information processing device 70, for example, software for the processing of the form of the present embodiment can be installed via network communication by the communication unit 80 or the removable recording medium 82. Alternatively, the software may be stored in advance in the ROM 72, the storage unit 79, or the like.

The information processing device 70 can function as the spectral information generation device 50 of the embodiment by installing a program for executing the processing described in FIGS. 9, 10, and 12 in the CPU 71.

### 4. Notes

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

FIG. 15 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 15 is a functional block diagram illustrating a networked system 800 of one or more networked computers and servers. In an embodiment, the hardware and software environment illustrated in FIG. 15 may provide an exemplary platform for imple-mentation of the software and/or methods according to the present disclosure.

Referring to FIG. 15, a networked system 800 may include, but is not limited to, computer 805, network 810, remote computer 815, web server 820, cloud storage server 825 and compute server 830. In some embodiments, multiple instances of one or more of the functional blocks illustrated in FIG. 15 may be employed.

Additional detail of computer 805 is shown in FIG. 15. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM).

Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 5. Summary and Modifications

In the above embodiments, the following effects can be obtained.

The spectral information generation device 50 of the embodiment includes the spectroscopic camera 30A configured to output spectral information SS1 that is an imaging signal for each of a plurality of wavelength bands, the spectroscopic camera 30B configured to output spectral information SS2 that is an imaging signal for each of a plurality of wavelength bands different from the plurality of wavelength bands of the spectroscopic camera 30A but partially including wavelength bands common to the plurality of wavelength bands of the spectroscopic camera 30A, and the spectral information generation device 50. In addition, the spectral information generation device 50 includes the distance information calculation unit 20 configured to calculate the distance information DS from the spectral information SS1 and SS2 and the spectroscopic processing unit 10 configured to generate the output spectral information GB from the spectral information SS1 and SS2 (see FIG. 4).

It is assumed that the first spectral information SS1 and the second spectral information SS2 include information regarding a plurality of wavelength bands different from each other and partially include information regarding common wavelength bands. By having information regarding wavelength bands different from each other, it is possible to obtain the output spectral information GB having a higher spectral resolution using the spectral information SS1 and SS2 from the spectroscopic cameras 30A and 30B.

In addition, since the spectral information SS1 and SS2 include information regarding common wavelength bands it is possible to obtain two luminance images G1 and G2 having close conditions suitable for calculating distance information.

That is, it is possible to achieve both improvement in resolution and appropriate distance information calculation.

In the embodiment, an example is described in which the spectroscopic processing unit 10 generates the output spectral information GB by synthesizing the spectral information SS1 and SS2.

The spectral information SS1 and the spectral information SS2 include information regarding wavelength bands different from each other. Therefore, by synthesizing the spectral information SS1 and the spectral information SS2 into the output spectral information GB, spectral information with higher resolution can be output.

In the embodiment, an example is described in which the spectroscopic processing unit 10 detects the same subject in the spectral information SS1 and SS2 and synthesizes the spectral information SS1 and SS2 for each pixel position of the same subject to generate the output spectral information.

The spectral information SS1 and the spectral information SS2 include information regarding wavelength bands different from each other, but have parallax. Therefore, after the pixel position of the same subject is determined, the spectral information SS1 and the spectral information SS2 are synthesized for each pixel to be the output spectral information GB, whereby spectral information with higher resolution can be output.

In the embodiment, an example is described in which the distance information calculation unit 20 calculates the distance information DS using the luminance image G1 generated from the spectral information SS1 and the luminance image G2 generated from the spectral information SS2.

Since the spectral information SS1 and SS2 have information regarding partially overlapping wavelength bands, images suitable for distance calculation can be obtained as the luminance images G1 and G2.

In the exemplary embodiment, an example is described in which the distance information calculation unit 20 calculates parallax information D of the luminance image G1 and the luminance image G2, and calculates distance information DS on the basis of parallax information D.

Since the spectral information SS1 and SS2 have information regarding partially overlapping wavelength bands, it is possible to obtain images suitable for calculating the parallax information D as the luminance images G1 and G2. The distance information DS (depth) can be obtained by obtaining the parallax information D.

In the spectral information generation system 100 of the embodiment, the spectroscopic camera 30A includes the spectral filter group 31A in which each of the pixel color filters of the plurality of pass wavelength bands corresponds to a pixel, and captures an image with the spectral filter group 31A interposed therebetween, thereby outputting spectral information SS1 that is an imaging signal for each of a plurality of wavelength bands. In addition, the spectroscopic camera 30B includes the spectral filter group 31B in which each of a plurality of pixel color filters having pass wavelength bands different from the plurality of pass wavelength bands of the spectral filter group 31A but partially including pass wavelength bands common to the plurality of pass wavelength bands of the spectral filter group 31A corresponds to a pixel, and captures an image through the spectral filter group 31B, thereby outputting spectral information SS2 that is an imaging signal for each of a plurality of wavelength bands.

That is, the spectral filter group 31A and the spectral filter group 31B include pixel color filters of a plurality of pass wavelength bands, and partially includes common pass wavelength bands while they are filter groups including a plurality of pass wavelength bands different from each other. As a result, the spectral information SS1 and the spectral information SS2 can include information regarding a plurality of wavelength bands different from each other and partially include information regarding common wavelength bands.

In the embodiment, for the spectral filter group 31A and the spectral filter group 31B, an example is described in which a section in which the pass wavelength bands of the pixel color filters of the spectral filter group 31A and the pass wavelength bands of the pixel color filters of the spectral filter group 31B are alternately disposed from the low wavelength side to the high wavelength side while partially including common wavelength bands is provided.

For example, as illustrated in FIG. 7, the spectral filter group 31 has odd-numbered pass wavelength bands, and the spectral filter group 32 has even-numbered pass wavelength bands, and the pass wavelength bands overlap each other in the vicinity of the boundary of the pass wavelength bands. As a result, spectral information SS1 and SS2 suitable for improving the spectral resolution and calculating the distance information can be obtained.

Note that, in FIG. 7, the pass wavelength bands of the pixel color filters of the spectral filter groups 31A and 31B are alternately disposed in the entire section of the wavelength bands at which an image is captured, but may be alternately disposed in the partial section of the wavelength bands at which an image is captured.

In the embodiment, an example is described in which, in the spectral filter group 31A, some pixel color filters are filters of pass wavelength bands common to pass wavelength bands of some pixel color filters of the spectral filter group 31B, and other pixel color filters are filters of pass wavelength bands that are not provided in the spectral filter group 31B.

For example, as illustrated in FIG. 8, the pixel color filter (F15) of the spectral filter group 31A and the pixel color filter (F16) of the spectral filter group 31B have the same pass wavelength band. The others are pass wavelength bands different from each other. This also makes it possible to obtain the spectral information SS1 and SS2 suitable for improving the spectral resolution and calculating the distance information.

Note that, in FIG. 8, in each of the spectral filter groups 31A and 31B, one pixel color filter (F15, F16) has a common pass wavelength band, but a plurality of pass wavelength bands may have common pass wavelength bands.

In the embodiment, an example is described in which some pixel color filters having common pass wavelength bands in the spectral filter groups 31A and 31B are filters having pass wavelength bands wider than those of the other pixel color filters having no common pass wavelength band.

For example, in the case of FIG. 8, the pixel color filter (F15) of the spectral filter group 31A and the pixel color filter (F16) of the spectral filter group 31B are filters having the same pass wavelength band and having a wide wavelength band unlike the other pixel color filters. In order to calculate the distance information, luminance images under the same conditions are desirable, and therefore it is preferable that the common wavelength band is wide. Therefore, it is preferable to obtain information regarding a wide wavelength band such as the pixel color filter (F15, F16).

Note that the spectroscopic cameras 30A and 30B include spectroscopic sensors having different spectral sensitivities by the spectral filter groups 31A and 31B, but other examples are also conceivable.

For example, since the spectroscopic cameras 30A and 30B include band pass filters different from each other, the spectral information SS1 and SS2 can include captured images in wavelength bands different from each other and partially include images in common wavelength bands.

Note that the effects described in the present specification are merely examples and are not limited, and other effects may be provided.

Note that the present technology can also employ the following configurations.

(1)

A spectral information generation device including
a distance information calculation unit configured to calculate distance information on the basis of first spectral information that is an imaging signal for each of a plurality of wavelength bands of a first spectroscopic camera and second spectral information that is an imaging signal for each of a plurality of wavelength bands, of a second spectroscopic camera, different from the plurality of wavelength bands of the first spectroscopic camera but partially including wavelength bands common to the plurality of wavelength bands of the first spectroscopic camera, and
a spectroscopic processing unit configured to generate output spectral information on the basis of the first spectral information and the second spectral information.
   (2)

The spectral information generation device according to Item (1), in which the spectroscopic processing unit
synthesizes the first spectral information and the second spectral information to generate the output spectral information.
(3)

The spectral information generation device according to Item (1) or (2), in which the spectroscopic processing unit
detects a same subject in the first spectral information and the second spectral information to synthesize the first spectral information and the second spectral information for each pixel position of the same subject to generate the output spectral information.
(4)

The spectral information generation device according to any one of Items (1) to (3), in which the distance information calculation unit
calculates distance information using a first luminance image generated from the first spectral information and a second luminance image generated from the second spectral information.
(5)

The spectral information generation device according to any one of Items (1) to (4), in which
the distance information calculation unit
calculates parallax information regarding a first luminance image generated from the first spectral information and a second luminance image generated from the second spectral information, and calculates distance information on the basis of the parallax information.
(6)

A spectral information generation system including
a first spectroscopic camera configured to output first spectral information that is an imaging signal for each of a plurality of wavelength bands,
a second spectroscopic camera configured to output second spectral information that is an imaging signal for each of a plurality of wavelength bands different from the plurality of wavelength bands of the first spectroscopic camera but partially including wavelength bands common to the plurality of wavelength bands of the first spectroscopic camera, a distance information calculation unit configured to calculate distance information from the first spectral information and the second spectral information, and
a spectroscopic processing unit configured to generate output spectral information from the first spectral information and the second spectral information.
   (7)

The spectral information generation system according to Item (6), in which the first spectroscopic camera includes a first spectral filter group in which each of filters of a plurality of pass wavelength bands corresponds to a pixel, and captures an image through the first spectral filter group to output the first spectral information that is an imaging signal for each of a plurality of wavelength bands, and in which the second spectroscopic camera includes a second spectral filter group in which each of a plurality of filters of a plurality of pass wavelength bands different from the plurality of pass wavelength bands of the first spectral filter group but partially including pass wavelength bands common to the plurality of pass wavelength bands of the first spectral filter group corresponds to a pixel, and captures an image through the second spectral filter group to output the second spectral information that is an imaging signal for each of a plurality of wavelength bands.

(8)

The spectral information generation system according to Item (7), in which with respect to the first spectral filter group and the second spectral filter group, a section in which pass wavelength bands of filters of the first spectral filter group and pass wavelength bands of filters of the second spectral filter group are alternately disposed from a low wavelength side to a high wavelength side while partially including common wavelength bands is provided.

(9)

The spectral information generation system according to Item (7) or (8), in which in the first spectral filter group, some filters are filters of pass wavelength bands common to pass wavelength bands of some filters of the second spectral filter group, and other filters are filters, of pass wavelength bands, that are not provided in the second spectral filter group.

(10)

The spectral information generation system according to Item (9), in which the some filters are filters having pass wavelength bands wider than pass wavelength bands of the other filters.

(11)

A spectral information generation method including
a first spectroscopic camera outputs outputting first spectral information that is an imaging signal for each of a plurality of wavelength bands,
a second spectroscopic camera outputting second spectral information that is an imaging signal for each of a plurality of wavelength bands different from the plurality of wavelength bands of the first spectroscopic camera but partially including wavelength bands common to the plurality of wavelength bands of the first spectroscopic camera,
calculating distance information from the first spectral information and the second spectral information, and
generating output spectral information from the first spectral information and the second spectral information.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

3 Spectroscopic camera
4 Spectroscopic sensor
Spectroscopic processing unit
11 space calibration unit
12 Spectral information synthesis unit
20 Distance information calculation unit
30A, 30B Spectroscopic camera
31A, 31B Spectral filter group
50 Processor (information processing device)
100 Spectral information generation device
SS1, SS2 Spectral information
GB Output spectral information
DS Distance information
G1, G2 luminance image
D Parallax information

1. A spectral information generation device comprising:
a distance information calculation unit configured to calculate distance information on a basis of first spectral information that is an imaging signal for each of a plurality of wavelength bands of a first spectroscopic camera and second spectral information that is an imaging signal for each of a plurality of wavelength bands, of a second spectroscopic camera, different from the plurality of wavelength bands of the first spectroscopic camera but partially including wavelength bands common to the plurality of wavelength bands of the first spectroscopic camera; and
a spectroscopic processing unit configured to generate output spectral information on a basis of the first spectral information and the second spectral information.

2. The spectral information generation device according to claim 1, wherein
the spectroscopic processing unit
synthesizes the first spectral information and the second spectral information to generate the output spectral information.

3. The spectral information generation device according to claim 1, wherein
the spectroscopic processing unit
detects a same subject in the first spectral information and the second spectral information to synthesize the first spectral information and the second spectral information for each pixel position of the same subject to generate the output spectral information.

4. The spectral information generation device according to claim 1, wherein
the distance information calculation unit
calculates distance information using a first luminance image generated from the first spectral information and a second luminance image generated from the second spectral information.

5. The spectral information generation device according to claim 1, wherein
the distance information calculation unit
calculates parallax information regarding a first luminance image generated from the first spectral information and a second luminance image generated from the second spectral information, and calculates distance information on a basis of the parallax information.

6. A spectral information generation system comprising:
a first spectroscopic camera configured to output first spectral information that is an imaging signal for each of a plurality of wavelength bands;
a second spectroscopic camera configured to output second spectral information that is an imaging signal for each of a plurality of wavelength bands different from the plurality of wavelength bands of the first spectroscopic camera but partially including wavelength bands common to the plurality of wavelength bands of the first spectroscopic camera;
a distance information calculation unit configured to calculate distance information from the first spectral information and the second spectral information; and
a spectroscopic processing unit configured to generate output spectral information from the first spectral information and the second spectral information.

7. The spectral information generation system according to claim 6, wherein
the first spectroscopic camera includes a first spectral filter group in which each of filters of a plurality of pass wavelength bands corresponds to a pixel, and captures an image through the first spectral filter group to output the first spectral information that is an imaging signal for each of a plurality of wavelength bands, and wherein
the second spectroscopic camera includes a second spectral filter group in which each of a plurality of filters of a plurality of pass wavelength bands different from the plurality of pass wavelength bands of the first spectral filter group but partially including pass wavelength bands common to the plurality of pass wavelength bands of the first spectral filter group corresponds to a pixel, and captures an image through the second spectral filter group to output the second spectral information that is an imaging signal for each of a plurality of wavelength bands.

8. The spectral information generation system according to claim 7, wherein
with respect to the first spectral filter group and the second spectral filter group,
a section in which pass wavelength bands of filters of the first spectral filter group and pass wavelength bands of filters of the second spectral filter group are alternately disposed from a low wavelength side to a high wavelength side while partially including common wavelength bands is provided.

9. The spectral information generation system according to claim 7, wherein
in the first spectral filter group, some filters are filters of pass wavelength bands common to pass wavelength bands of some filters of the second spectral filter group, and other filters are filters, of pass wavelength bands, that are not provided in the second spectral filter group.

10. The spectral information generation system according to claim 9, wherein
the some filters are filters having pass wavelength bands wider than pass wavelength bands of the other filters.

11. A spectral information generation method comprising:
a first spectroscopic camera outputting first spectral information that is an imaging signal for each of a plurality of wavelength bands;
a second spectroscopic camera outputting second spectral information that is an imaging signal for each of a plurality of wavelength bands different from the plurality of wavelength bands of the first spectroscopic camera but partially including wavelength bands common to the plurality of wavelength bands of the first spectroscopic camera;
calculating distance information from the first spectral information and the second spectral information; and
generating output spectral information from the first spectral information and the second spectral information.
